(19) United States
(12) Patent Application Publication
(10) Pub. No.: US 2025/0302070 A1
(43) Pub. Date: Oct. 2, 2025

(54) PROBIOTIC CAT FOOD FOR IMPROVING DIGESTIVE FUNCTION OF PET CAT AND PREPARATION METHOD THEREOF

(71) Applicant: Food Laboratory of Zhongyuan, Luohe (CN)

(72) Inventors: Wei Xiong, Luohe (CN); Weiwei Wang, Luohe (CN); Ran Wang, Beijing (CN); Shaoyang Ge, Beijing (CN)

(21) Appl. No.: 18/911,191

(22) Filed: Oct. 9, 2024

(30) Foreign Application Priority Data
Mar. 28, 2024 (CN) 202410361405.1

(51) Int. Cl. A23K 10/18; A23K 10/22; A23K 10/35; A23K 20/142; A23K 20/163; A23K 20/174; A23K 20/22; A23K 20/24; A23K 20/26; A23K 40/10; A23K 40/30; A23K 50/42

(52) U.S. Cl. CPC A23K 10/18; A23K 10/22; A23K 10/35; A23K 20/142; A23K 20/163; A23K 20/174; A23K 20/22; A23K 20/24; A23K 20/26; A23K 40/10; A23K 40/30; A23K 50/42; A23V 2400/169; A23V 2400/515; A23V 2400/531

(57) ABSTRACT

The present disclosure belongs to the technical field of pet food technology, and specifically to a probiotic cat food for improving digestive function of pet cat and preparation method thereof. The probiotic cat food, composed of an ingredient and a probiotic composition, the probiotic composition is composed of Bifidobacterium animalis subsp.lactis U9 and Lactobacillus plantarum CR12. The present disclosure, by specific formula and processing technology (three-stage low-temperature baking+probiotic cold-spraying), not only protects vitamins, amino acids, and certain bioactive substances in the cat foods from being destroyed, but also improves the taste of the foods, enhances the digestibility, and effectively ensures the activity of the probiotic composition.

### CROSS-REFERENCE TO RELATED APPLICATION

This application claims priority of Chinese Patent Application No. 202410361405.1, filed on Mar. 28, 2024, the entire contents of which are incorporated herein by reference.

### TECHNICAL FIELD

The present disclosure belongs to the technical field of pet food technology, and specifically to a probiotic cat food for improving digestive function of pet cat and preparation method thereof.

### BACKGROUND

With the popularization of pet cats and the increasing attention of pet owners to the pet health, the quality and functionality of cat foods become an important research direction. At present, the cat foods on the market mainly focus on supplementing basic nutrients, but neglecting the special digestive system needs and intestinal health of the cats. The cat, as a strict carnivore, has a shorter intestinal tract and limited ability to absorb nutrient substances, thus it is susceptible to problems such as imbalanced intestinal microbiota and indigestion. At present, probiotics are widely researched and applied due to its potential in improving the digestive health. The probiotics have a significant positive effect on improving host intestinal health, maintaining intestinal microbiota balance, and enhancing nutrient absorption rate. However, the probiotics have strict requirements for temperature, humidity, and storage conditions. Traditional cat food production processes such as high-temperature extruding and drying may destroy the activity of the probiotics. Effectively integrating the probiotics into the cat foods and ensuring its activity and stability during production, processing, storage, and cat consumption is a technical challenge.

Therefore, developing a functional cat food that may improve the cat digestive function and regulate intestinal microbiota balance is of great significance for improving the quality of life of the pet cats.

### SUMMARY

The object of the prior art of the invention is to provide a probiotic cat food for improving digestive function of pet cat and preparation method thereof. The present disclosure solves the problem of pet cat intestinal health neglected in existing cat foods by adding a specific probiotic composition. The probiotic cat food not only has balanced nutrition, but also may effectively regulate the intestinal health of pet cats, improve the digestive ability of the pet cats, and enhance the immune function of the pet cats.

The object of the present invention is realized by the following technical scheme:

The first aspect of the present invention provides a probiotic cat food for improving a digestive function of a pet cat, composed of an ingredient and a probiotic composition, characterized in that the probiotic composition is composed of Bifidobacterium animalis subsp.lactis U9 and Lactobacillus plantarum CR12;

Bifidobacterium animalis subsp.lactis U9, having a preservation number of CGMCC No. 11560;

Lactobacillus plantarum CR12, having a preservation number of CGMCC No. 14000; the ingredient is calculated in parts by weight and comprises:

60 parts of fresh chicken, 15 parts of deboned chicken, 3 parts of fresh chicken liver, 3 parts of sweet potato flour, 3 parts of whole egg powder, 3 parts of chicken oil, 4 parts of fish oil, 3 parts of cassava starch, 0.7 parts of fresh pumpkin, 0.7 parts of broccoli, 0.7 parts of celery, 0.7 parts of carrots, 0.4 parts of beer yeast powder, 0.3 parts of seaweed powder, 0.2 parts of plantain seed powder, 0.3 parts of dried cranberries, and 2 parts of additives; and

the viable count of the Bifidobacterium animalis subsp.lactis U9 in the probiotic cat food is 1×10¹⁰ CFU/kg, the viable count of the Lactobacillus plantarum CR12 in the probiotic cat food is 1×10¹⁰ CFU/kg.

Further, the additives comprise: taurine, choline chloride, sodium chloride, potassium chloride, calcium hydrogen phosphate, fructooligosaccharide, mannan oligosaccharide, rosemary extract, tea polyphenol, vitamin A acetate, vitamin D₃, dl-α-tocopherol, thiamine nitrate (vitamin B₁), riboflavin (vitamin B₂), niacin, D-calcium pantothenate, pyridoxine hydrochloride (vitamin B₆), folate, D-biotin, cyanocobalamin (vitamin B₁₂), glycine copper chelate, glycine iron chelate, glycine zinc, methionine manganese complex, calcium iodate, and yucca schidigera extract.

The second aspect of the present invention provides a preparation method for the probiotic cat food for improving the digestive function of the pet cat, comprising the following steps:
(1) weighting the ingredients according to parts by weight, and mixing the ingredients evenly after chopping and stirring treatment;
(2) adding the evenly mixed ingredients to a granulator, and performing shaping treatment to obtain cat food granules; and
(3) performing three-stage low-temperature baking on the cat food granules, to obtain a baked food; wherein the conditions for the three-stage low-temperature baking are: baking at 90-100° C. for 30 min, baking at 100-120° C. for 30 min, baking at 80-100° C. for 3 h;
(4) weighing the Bifidobacterium animalis subsp.lactis U9 and Lactobacillus plantarum CR12 powder according to the viable count, and dissolving to obtain probiotic mixed solution; after cooling the baked food, evenly spraying the probiotic mixed solution on the surface of the baked food by using a spraying device, and after the spraying, naturally air-drying the cat food in a sterile and ventilated environment, to obtain the probiotic cat food for improving the digestive function of the pet cat.

The Bifidobacterium animalis subsp.lactis U9 is preserved in China General Microbiological Culture Collection Center (CGMCC) on Nov. 4, 2015, the address is Institute of Microbiology, Chinese Academy of Sciences, No. 3, No. 1 Yard, Beichen West Road, Chaoyang District, Beijing, the postal code is 100101, and the preservation number is CGMCC No. 11560.

The Lactobacillus plantarum CR 12 is preserved in China General Microbiological Culture Collection Center (CGMCC) on Apr. 7, 2017, the address is Institute of Microbiology, Chinese Academy of Sciences, No. 3, No. 1 Yard, Beichen West Road, Chaoyang District, Beijing, the postal code is 100101, and the preservation number is CGMCC No. 14000.

### The Beneficial Effects of the Present Disclosure are as Follows.

1. The probiotic cat food of the present disclosure contains the probiotic composition composed of Bifidobacterium animalis subsp.lactis U9 and Lactobacillus plantarum CR12, which may effectively regulate the balance of cat intestinal microbiota, and enhance the intestinal mucosal barrier function of the cats, thereby the digestive ability and overall health of the cats are improved. By experimental verification, the cat food of the present disclosure may significantly improve the intestinal microbiota structure of the cats, enhance the intestinal immune function, improve the serum antioxidant capacity, and regulate serum inflammatory factors, and it shows excellent probiotic effects.

2. The present disclosure, by specific formula and processing technology (three-stage low-temperature baking+probiotic cold-spraying), not only protects vitamins, amino acids, and certain bioactive substances in the cat foods from being destroyed, but also improves the taste of the foods, enhances the digestibility, and effectively ensures the activity of the probiotic composition.

### DETAILED DESCRIPTION OF THE EMBODIMENTS

The given embodiments are intended to better illustrate the invention, but the invention is not limited to the given embodiments. Therefore, technicians skilled in the field make non-essential improvements and adjustments to the implementation plan according to the above invention, which still falls within the scope of protection of the invention.

The endpoints and any values of the range disclosed herein are not limited to that exact range or value and shall be understood to contain values close to these ranges or values. For numerical ranges, between endpoint values, between endpoint values and individual point values, and individual point values may be combined to obtain one or more new numerical ranges which shall be considered as disclosed herein.

The present invention will be described in detail below by embodiments. It should be understood that the following embodiments are used only for exemplary further detailed explanation and description of the contents of the invention, and not for limiting the invention.

The Bifidobacterium animalis subsp.lactis U9 is preserved in China General Microbiological Culture Collection Center (CGMCC) on Nov. 4, 2015, the address is Institute of Microbiology, Chinese Academy of Sciences, No. 3, No. 1 Yard, Beichen West Road, Chaoyang District, Beijing, the postal code is 100101, and the preservation number is CGMCC No. 11560.

The Lactobacillus plantarum CR 12 is preserved in China General Microbiological Culture Collection Center (CGMCC) on Apr. 7, 2017, the address is Institute of Microbiology, Chinese Academy of Sciences, No. 3, No. 1 Yard, Beichen West Road, Chaoyang District, Beijing, the postal code is 100101, and the preservation number is CGMCC No. 14000.

### Embodiment 1

This embodiment provides a probiotic cat food for improving a digestive function of a pet cat, composed of an ingredient and a probiotic composition, characterized in that the probiotic composition is composed of Bifidobacterium animalis subsp.lactis U9 and Lactobacillus plantarum CR12.

Bifidobacterium animalis subsp.lactis U9, having a preservation number of CGMCC No. 11560;

Lactobacillus plantarum CR12, having a preservation number of CGMCC No. 14000. The ingredient is calculated in parts by weight and comprises:

60 parts of fresh chicken, 15 parts of deboned chicken, 3 parts of fresh chicken liver, 3 parts of sweet potato flour, 3 parts of whole egg powder, 3 parts of chicken oil, 4 parts of fish oil, 3 parts of cassava starch, 0.7 parts of fresh pumpkin, 0.7 parts of broccoli, 0.7 parts of celery, 0.7 parts of carrots, 0.4 parts of beer yeast powder, 0.3 parts of seaweed powder, 0.2 parts of plantain seed powder, 0.3 parts of dried cranberries, and 2 parts of additives.

The viable count of the Bifidobacterium animalis subsp.lactis U9 in the probiotic cat food is 1×10¹⁰ CFU/kg, the viable count of the Lactobacillus plantarum CR12 in the probiotic cat food is 1×10¹⁰ CFU/kg.

The additives in this embodiment were purchased from Shandong han Ou Biotechnology Co., Ltd. and the commodity name is baked cat food additive.

The preparation method for the probiotic cat food, comprising the following steps:
(1) weighting the ingredients according to parts by weight, and adding to the chop mixer (model: ZBJ-20, voltage: 380V, power: 2.25 kw) and mix for 10 min, and mix the ingredients well.
(2) adding the evenly mixed ingredients to a granulator (model: 47511153, voltage: 220V, power: 650w, granulation diameter of 6 mm), and performing shaping treatment to obtain cat food granules.
(3) performing three-stage low-temperature baking on the cat food granules, to obtain a baked food, wherein the conditions for the three-stage low-temperature baking are: baking at 90-100° C. for 30 min, baking at 100-120° C. for 30 min, baking at 80-100° C. for 3 h.
(4) weighing the Bifidobacterium animalis subsp.lactis U9 and Lactobacillus plantarum CR12 powder according to the viable count, and dissolving to obtain probiotic mixed solution; after cooling the baked food, evenly spraying the probiotic mixed solution on the surface of the baked food by using a spraying device (model: SYPZ1000, Voltage: 380V, power: 1.5 kW), and after the spraying, naturally air-drying the cat food in a sterile and ventilated environment, to obtain the probiotic cat food for improving the digestive function of the pet cat.
(5) packaging and encapsulating: packaging and encapsulating the prepared probiotic cat food, to ensure the product freshness and hygiene standards.

### Contrast Example 1

The Contrast example 1 provides a cat food without added probiotics, the ingredient is calculated in parts by weight and comprises:

60 parts of fresh chicken, 15 parts of deboned chicken, 3 parts of fresh chicken liver, 3 parts of sweet potato flour, 3 parts of whole egg powder, 3 parts of chicken oil, 4 parts of fish oil, 3 parts of cassava starch, 0.7 parts of fresh pumpkin, 0.7 parts of broccoli, 0.7 parts of celery, 0.7 parts of carrots, 0.4 parts of beer yeast powder, 0.3 parts of seaweed powder, 0.2 parts of plantain seed powder, 0.3 parts of dried cranberries, and 2 parts of additives.

The preparation method for the cat food, comprising the following steps:
(1) weighting the ingredients according to parts by weight, and adding to the chop mixer (model: ZBJ-20, voltage: 380V, power: 2.25 kw) and mix for 10 min, and mix the ingredients well.
(2) adding the evenly mixed ingredients to a granulator (model: 47511153, voltage: 220V, power: 650w, granulation diameter of 6 mm), and performing shaping treatment to obtain cat food granules.
(3) performing three-stage low-temperature baking on the cat food granules, to obtain a baked food, that is, the cat food without probiotics.
wherein the conditions for the three-stage low-temperature baking are: baking at 90-100° C. for 30 min, baking at 100-120° C. for 30 min, baking at 80-100° C. for 3 h.
(4) packaging and encapsulating: packaging and encapsulating the prepared cat food, to ensure the product freshness and hygiene standards.

### Contrast Example 2

This embodiment provides a probiotic cat food, composed of an ingredient and a probiotic composition, the probiotic composition is Bifidobacterium animalis subsp.lactis U9, having a preservation number of CGMCC No. 11560.

The ingredient is calculated in parts by weight and comprises:

60 parts of fresh chicken, 15 parts of deboned chicken, 3 parts of fresh chicken liver, 3 parts of sweet potato flour, 3 parts of whole egg powder, 3 parts of chicken oil, 4 parts of fish oil, 3 parts of cassava starch, 0.7 parts of fresh pumpkin, 0.7 parts of broccoli, 0.7 parts of celery, 0.7 parts of carrots, 0.4 parts of beer yeast powder, 0.3 parts of seaweed powder, 0.2 parts of plantain seed powder, 0.3 parts of dried cranberries, and 2 parts of additives.

The viable count of the Bifidobacterium animalis subsp.lactis U9 in the probiotic cat food is 2×10¹⁰ CFU/kg.

The preparation method and raw materials of the probiotic cat food were referred to Embodiment 1.

### Contrast Example 3

This embodiment provides a probiotic cat food, composed of an ingredient and a probiotic composition, the probiotic composition is Lactobacillus plantarum CR12, having a preservation number of CGMCC No. 14000.

The ingredient is calculated in parts by weight and comprises:

60 parts of fresh chicken, 15 parts of deboned chicken, 3 parts of fresh chicken liver, 3 parts of sweet potato flour, 3 parts of whole egg powder, 3 parts of chicken oil, 4 parts of fish oil, 3 parts of cassava starch, 0.7 parts of fresh pumpkin, 0.7 parts of broccoli, 0.7 parts of celery, 0.7 parts of carrots, 0.4 parts of beer yeast powder, 0.3 parts of seaweed powder, 0.2 parts of plantain seed powder, 0.3 parts of dried cranberries, and 2 parts of additives.

The viable count of the Lactobacillus plantarum CR12 in the probiotic cat food is 2×10¹⁰ CFU/kg.

The preparation method and raw materials of the probiotic cat food were referred to Embodiment 1.

### Contrast Example 4

This contrast example provided a commercially available cat food, the ingredient is calculated in parts by weight and comprises: 25 parts of fresh chicken, 19 parts of chicken powder, 13 parts of herring powder, 10 parts of corn, 8 parts of brown rice, 6.1 parts of chicken oil, 5 parts of turkey meat powder, 3 parts of sugar beet pulp, 2 parts of alfalfa granules, 2 parts of fish oil, 2 parts of egg powder, 1 part of pumpkin, 1 part of beer yeast powder, 0.6 parts of carrots, 0.1 parts of spirulina powder, 0.1 parts of plantain seed, 0.1 parts of a yucca schidigera extract, and 2 parts of additives.

The preparation method for the commercially available cat food was referred to Contrast example 1.

### Contrast Example 5

This embodiment provides a probiotic cat food for improving a digestive function of a pet cat, composed of an ingredient and a probiotic composition, characterized in that the probiotic composition is composed of Bifidobacterium animalis subsp.lactis U9, Lactobacillus plantarum CR12, and Lactobacillus paracasei L55 (CGMCC No. 13996).

The ingredient is calculated in parts by weight and comprises:

60 parts of fresh chicken, 15 parts of deboned chicken, 3 parts of fresh chicken liver, 3 parts of sweet potato flour, 3 parts of whole egg powder, 3 parts of chicken oil, 4 parts of fish oil, 3 parts of cassava starch, 0.7 parts of fresh pumpkin, 0.7 parts of broccoli, 0.7 parts of celery, 0.7 parts of carrots, 0.4 parts of beer yeast powder, 0.3 parts of seaweed powder, 0.2 parts of plantain seed powder, 0.3 parts of dried cranberries, and 2 parts of additives.

The viable count of the Bifidobacterium animalis subsp.lactis U9 in the probiotic cat food is 1×10¹⁰ CFU/kg, the viable count of the Lactobacillus plantarum CR12 in the probiotic cat food is 1×10¹⁰ CFU/kg and the viable count of the Lactobacillus paracasei L55 in the probiotic cat food is 1×10¹⁰ CFU/kg.

The preparation method and raw materials of the probiotic cat food were referred to Embodiment 1.

### Contrast Example 6

This embodiment provides a probiotic cat food for improving a digestive function of a pet cat, composed of an ingredient and a probiotic composition, characterized in that the probiotic composition is composed of Bifidobacterium animalis subsp.lactis U9, Lactobacillus plantarum CR12, Lactobacillus paracasei L55 and Lactobacillus rhamnosus LL23 (CGMCC No. 13994).

The ingredient is calculated in parts by weight and comprises:

60 parts of fresh chicken, 15 parts of deboned chicken, 3 parts of fresh chicken liver, 3 parts of sweet potato flour, 3 parts of whole egg powder, 3 parts of chicken oil, 4 parts of fish oil, 3 parts of cassava starch, 0.7 parts of fresh pumpkin, 0.7 parts of broccoli, 0.7 parts of celery, 0.7 parts of carrots, 0.4 parts of beer yeast powder, 0.3 parts of seaweed powder, 0.2 parts of plantain seed powder, 0.3 parts of dried cranberries, and 2 parts of additives.

The viable count of the Bifidobacterium animalis subsp.lactis U9 in the probiotic cat food is 1×10¹⁰ CFU/kg, the viable count of the Lactobacillus plantarum CR12 in the probiotic cat food is 1× 10¹⁰ CFU/kg, the viable count of the Lactobacillus paracasei L55 in the probiotic cat food is 1×10¹⁰ CFU/kg, the viable count of the Lactobacillus rhamnosus LL23 in the probiotic cat food is 1×10¹⁰ CFU/kg.

The preparation method and raw materials of the probiotic cat food were referred to Embodiment 1.

### Test Example 1: Testing of the Structure of Intestinal Microbiota

The cat foods prepared in Embodiment 1 and Contrast examples 1-6 were divided into 5 groups and used to feed pet cats respectively, there were 6 cats in each group, each cat was fed in a single cage for four weeks, necessary immunization and deworming treatment was performed before the experiment, and the cat house was naturally ventilated and illuminated. The indoor temperature was maintained at 18° C.˜26° C., and the relative humidity was maintained at 40%˜70%. Feces were cleaned once in the morning and once in the evening, the cat house was cleaned and disinfected every day, and the pet pen was kept clean. After the fourth week of feeding, fresh fecal samples were collected by using a metabolic cage and stored at −80° C. DNA was extracted, the structure of intestinal microbiota was analyzed by using PacBio third-generation high-throughput sequencing, and the relative abundance of the main changed microbiota was shown in Table 1.

TABLE 1
Test results of intestinal microbiota structure of
pet cats in Embodiment 1 and Contrast examples 1-6

| Bacteria genus | Peptoclostridium | Collinsella | Megasphaera | Lactobacillus | Blautia | Bacteroides |
|---|---|---|---|---|---|---|
| Embodiment 1 | 18.19 | 16.70 | 10.41 | 20.59 | 5.62 | 1.57 |
| Contrast | 32.47 | 22.04 | 3.11 | 0.94 | 5.82 | 3.69 |
| example 1 | | | | | | |
| Contrast | 19.72 | 18.44 | 8.66 | 4.58 | 4.51 | 2.33 |
| example 2 | | | | | | |
| Contrast | 21.33 | 23.92 | 9.74 | 5.42 | 5.78 | 3.53 |
| example 3 | | | | | | |
| Contrast | 22.16 | 20.25 | 18.79 | 0.88 | 6.61 | 2.43 |
| example 4 | | | | | | |
| Contrast | 23.31 | 17.29 | 12.62 | 15.44 | 6.32 | 3.32 |
| example 5 | | | | | | |
| Contrast | 19.23 | 18.46 | 11.93 | 14.23 | 7.73 | 4.62 |
| example 6 | | | | | | |

As can be seen from Table 1, the probiotic cat food prepared in Embodiment 1 had the most significant impact on the structure of cat microbiota. After consuming the probiotic cat food in Embodiment 1, the relative abundance of Lactobacillus in the cat intestine was significantly increased, while the abundance of Peptoclostridium and Collinsella was significantly decreased compared to Contrast example 1. Compared with the cat foods in Contrast examples 2-4, the increase in the intestinal microbiota was mainly due to probiotics. This result indicated that the formula of the present disclosure might improve the intestinal microbiota and promote digestion.

### Test Example 2: Effect of Probiotic Cat Food on Intestinal Barrier Function of Pet Cats

This test example measured the contents of D-Lactic Acid (D-LA) and Diamine Oxidase (DAO) in the serum of two groups of the pet cats fed respectively with the cat foods in Contrast examples 1-6 and the probiotic cat food in Embodiment 1. This embodiment used a D-lactate assay kit and a diamine oxidase assay kit, and both were purchased from Beijing Sino-UK Institute of Biological Technology.

TABLE 2
Test results of intestinal barrier function of pet
cats in Embodiment 1 and Contrast examples 1-6

| Item | D-LA (mmol/L) | DAO (U/mL) |
|---|---|---|
| Embodiment 1 | 0.55 ± 0.12^{a} | 1.50 ± 0.07^{a} |
| Contrast example 1 | 0.79 ± 0.10^{c} | 1.94 ± 0.14^{c} |
| Contrast example 2 | 0.63 ± 0.17^{ab} | 1.67 ± 0.42^{b} |
| Contrast example 3 | 0.67 ± 0.11^{ab} | 1.79 ± 0.30^{b} |
| Contrast example 4 | 0.77 ± 0.08^{b} | 2.19 ± 0.27^{c} |
| Contrast example 5 | 0.64 ± 0.19^{ab} | 1.69 ± 0.43^{b} |
| Contrast example 6 | 0.68 ± 0.21^{ab} | 1.71 ± 0.28^{b} |

Note:
Different lowercase letters ^{(a-c)} represent significant differences between the two groups

As can be seen from Table 2, in Embodiment 1, a probiotic composition cat food feeding group significantly reduced the contents of D-LA and DAO in serum. D-LA was an organic acid generated by fermentation of certain bacteria in the intestine. Under normal circumstances, it existed in small amounts and might be excreted by the intestinal barrier. If the intestinal barrier function was impaired, the level of D-LA might increase in blood. This was because the damage to the intestinal barrier leaded to more D-LA entering the blood from the intestine. The main function of DAO was to decompose histamine generated by food and intestinal bacteria, prevent the excessive histamine from entering the blood circulation, and thus alleviate histamine related inflammation and allergic reactions. The increase of the probiotic composition might help competitively inhibit the growth of harmful microorganisms, thereby the inflammation and histamine production was reduced. Probiotics were beneficial live bacteria to a host, which might improve the balance of intestinal microecology and enhance the intestinal barrier function. Feeding the cat food containing the probiotics might help improve the barrier function of intestinal mucosa, thereby the serum levels of D-LA and DAO were reduced. This indicated that the integrity of the intestinal barrier was improved, and the penetration of harmful substances and pathogens was reduced, thereby the health of the host was maintained.

By comparison, it might be found that the serum levels of D-LA and DAO in the probiotic composition cat food feeding group in Embodiment 1 were significantly lower than those in a single strain cat food feeding group in Contrast examples 2 and 3. The serum levels of D-LA and DAO of the probiotic composition cat food feeding group in Embodiment 1 were significantly lower than those in three or four mixed strains cat food feeding group in Contrast examples 5 and 6. These indicated that the combination of Bifidobacterium animalis subsp.lactis U9 and Lactobacillus plantarum CR12 might significantly enhance the intestinal barrier function of pet cats.

### Test Example 3: Effect of Probiotic Cat Food on Intestinal Immune Function of Pet Cats

This test example measured the contents of immunoglobulin A (IgA) in the serum of two groups of the pet cats fed respectively with the cat foods in Contrast examples 1-6 and the probiotic cat food in Embodiment 1. This embodiment used a cat immunoglobulin IgG/A/M assay kit, and was purchased from Beijing Sino-UK Institute of Biological Technology.

TABLE 3
Test results of intestinal immune function of pet
cats in Embodiment 1 and Contrast examples 1-6

| Item | IgG (g/L) | IgM (g/L) | IgA (g/L) |
|---|---|---|---|
| Embodiment 1 | 7.11 ± 1.56^{a} | 0.88 ± 0.04^{a} | 1.70 ± 0.12^{a} |
| Contrast example 1 | 6.57 ± 0.73^{b} | 0.82 ± 0.10^{a} | 1.36 ± 0.10^{c} |
| Contrast example 2 | 6.92 ± 0.98^{ab} | 0.84 ± 0.05^{a} | 1.60 ± 0.23^{b} |
| Contrast example 3 | 7.01 ± 1.12^{a} | 0.82 ± 0.12^{a} | 1.55 ± 0.31^{b} |
| Contrast example 4 | 6.33 ± 0.41^{b} | 0.78 ± 0.21^{a} | 1.18 ± 0.17^{d} |
| Contrast example 5 | 7.12 ± 1.39^{a} | 0.84 ± 0.32^{a} | 1.57 ± 0.11^{b} |
| Contrast example 6 | 7.05 ± 0.52^{a} | 0.87 ± 0.26^{a} | 1.52 ± 0.29^{b} |

Note:
Different lowercase letters ^{(a-d)} represent significant differences between the two groups

As can be seen from Table 3, in Embodiment 1, the probiotic composition cat food feeding group significantly increased the content of IgA. IgA was an important antibody that mainly acted on the mucosal surface and was a key component of a mucosal immune system. It played a crucial role in maintaining intestinal health, preventing pathogen invasion, and regulating immune response. In addition, it increased the contents of immunoglobulin G (IgG) and immunoglobulin M (IgM) in serum.

### Test Example 4: Effect of Probiotic Cat Food on Serum Antioxidant Capacity of Pet Cats

This test example measured the contents of catalytic enzyme (CT), superoxide dismutase (SOD), glutathione peroxidase (GSH-Px), and total antioxidant capacity (T-AOC) in the serum of two groups of the pet cats fed respectively with the cat foods in Contrast examples 1˜4 and the probiotic cat food in Embodiment 1. This embodiment used a catalytic enzyme assay kit, a superoxide dismutase assay kit, a glutathione peroxidase assay kit, a total antioxidant capacity assay kit, and all were purchased from Beijing Sino-UK Institute of Biological Technology.

TABLE 4
Test results of serum antioxidant capacity of pet
cats in Embodiment 1 and Contrast examples 1-4

| | Embodiment | Contrast | Contrast | Contrast | Contrast |
|---|---|---|---|---|---|
| Item | 1 | example 1 | example 2 | example 3 | example 4 |
| MDA (nmol/mL) | 4.19 ± 0.17^{a} | 4.22 ± 0.38^{a} | 4.12 ± 0.12^{a} | 4.34 ± 0.23^{a} | 4.44 ± 0.41^{a} |
| CAT (U/mL) | 48.34 ± 2.74^{a} | 40.58 ± 2.13^{c} | 44.21 ± 1.12^{b} | 45.98 ± 1.3^{b} | 39.19 ± 3.21^{c} |
| SOD (U/mL) | 83.20 ± 3.55^{a} | 67.12 ± 1.83^{c} | 80.22 ± 2.71^{b} | 78.81 ± 3.62^{b} | 62.44 ± 4.01^{c} |
| GSH-PX (U/mL) | 192.0 ± 12.2^{a} | 157.7 ± 7.35^{b} | 166.2 ± 12.2^{b} | 159.1 ± 9.3^{b} | 162.9 ± 13.9^{b} |
| T-AOC (U/mL) | 10.38 ± 0.20^{a} | 9.25 ± 0.85^{a} | 10.02 ± 1.1^{a} | 9.01 ± 5.21^{a} | 9.55 ± 3.52^{a} |

Note:
Different lowercase letters ^{(a-c)} represent significant differences between the two groups

As can be seen from Table 4, eeding the probiotic cat food prepared in Embodiment 1 resulted in an increase in the levels of catalytic enzyme (CT), superoxide dismutase (SOD), glutathione peroxidase (GSH-Px), and total antioxidant capacity (T-AOC) in cat serum. These indicators were mainly related to an antioxidant defense system in the body and were crucial for resisting oxidative stress, preventing cell damage, and maintaining physiological function stability. CAT might quickly decompose hydroperoxides (H₂O₂) and reduce oxidative damages; SOD might convert a superoxide radical (O₂₋) into hydroperoxide and oxygen, which was the first line of defense against the oxidative stress; GSH-Px reduced a lipid peroxide to alcohol and reduced H₂O₂ to water, which protected cells from the oxidative damages; and T-AOC reflected the total level and overall antioxidant status of antioxidants in the body. Probiotics indirectly enhanced the antioxidant capacity of the body by improving the balance of intestinal microecology. The intestinal health was closely related to the overall level of the oxidative stress, and a healthy intestine might help alleviate the oxidative burden on the body. A good antioxidant state helped to protect the intestinal mucosa, improve the absorption efficiency of nutrients, and further enhance the health conditions and physiological functions of the body.

### Test Example 5: Effect of Probiotic Cat Food on Serum Inflammatory Factors of Pet Cats

This test example measured the contents of interleukin-4 (IL-4), interleukin-2 (IL-2), tumor necrosis factor-α (TNF-α), and interferon-γ (IFN-γ) in the serum of two groups of the pet cats fed respectively with the cat foods in Contrast examples 1-4 and the probiotic cat food in Embodiment 1. This embodiment used a IL-4 assay kit, a IL-2 assay kit, a TNF-α assay kit, a IFN-γ assay kit, and all were purchased from Beijing Sino-UK Institute of Biological Technology.

TABLE 5
Test results of serum inflammatory factors of pet cats in Embodiment 1 and Contrast examples 1-4

| | Embodiment | Contrast | Contrast | Contrast | Contrast |
|---|---|---|---|---|---|
| Item | 1 | example 1 | example 2 | example 3 | example 4 |
| IL-4 (pg/mL) | 7.94 ± 0.55^{a} | 5.60 ± 0.41^{c} | 6.1 ± 0.71^{b} | 6.2 ± 0.92^{b} | 5.33 ± 0.82^{c} |
| IL-2 (pg/mL) | 163.47 ± 3.38^{a} | 189.96 ± 6.38^{b} | 166.2 ± 8.27^{a} | 169.3 ± 9.91^{a} | 190.32 ± 3.43^{b} |
| TNF-α (pg/mL) | 42.94 ± 7.43^{a} | 58.39 ± 1.83^{b} | 44.32 ± 2.24^{a} | 45.61 ± 4.81^{a} | 61.88 ± 6.21^{b} |
| IFN-γ (pg/mL) | 23.48 ± 0.75^{a} | 29.15 ± 1.18^{c} | 28.25 ± 1.74^{c} | 26.33 ± 2.51^{b} | 30.41 ± 2.61^{c} |

Note:
Different lowercase letters ^{(a-c)} represent significant differences between the two groups

As can be seen from Table 5, feeding the probiotic cat food prepared in Embodiment 1 significantly increased the level of interleukin-4 (IL-4) in cat serum and significantly reduced the contents of interleukin-2 (IL-2), tumor necrosis factor-α (TNF-α), and interferon-γ (IFN-γ). IL-4 was a cytokine mainly generated by Th2 cells, which played a crucial role in regulating immune responses and promoting antibody generation. The increase of IL-4 indicated a positive Th2-type response trend in the immune system, this response was usually related to antiparasitic immunity and allergic reactions. In the non-allergic background, the increase of IL-4 helped promote B cell differentiation and the generation of IgE and other types of antibodies, which enhanced the immune defense of the body against specific pathogens. IL-2 was mainly generated by Th1 cells and was a key factor in T cell proliferation and activation in the immune system. The decrease of the IL-2 level might reflect inhibition of Th1-type immune response, this response was usually related to cell-mediated immune defense. TNF-α was an inflammatory cytokine mainly generated by macrophages, which was crucial for initiating inflammatory responses and resisting infections. However, overexpression of TNF-α was related to the development of various inflammatory and autoimmune diseases. The decrease of the TNF-α level might help reduce chronic inflammation and lower the risk of certain autoimmune conditions. IFN-γ was also generated by the Th1 cells and was a strong pro-inflammatory cytokine, which was crucial in combating viral and certain bacterial infections. The decrease of the IFN-γ level might indicate regulation of Th1-type immune response, which helped alleviate inflammation conditions associated with the excessive immune response.

In summary, feeding the probiotic cat food containing the probiotic composition composed of Bifidobacterium animalis subsp.lactis U9 and Lactobacillus plantarum CR12 may promote a healthier and more balanced immune environment by regulating the immune response in cats. These changes reflect the positive effects of the probiotic composition on the cat health, particularly in terms of regulating the immune system and reducing the risk of inflammatory diseases.

Finally, it should be noted that the above is only used to explain the technical scheme of the invention rather than the limitation, and although the invention is explained in detail according to the better arrangement scheme, the ordinary technicians in the field should understand that the technical scheme of the invention can be modified or replaced equally, without departing from the spirit and scope of the technical scheme of the invention.

1. A probiotic cat food for improving a digestive function of a pet cat, composed of an ingredient and a probiotic composition, characterized in that the probiotic composition is composed of only Bifidobacterium animalis subsp.lactis U9 and Lactobacillus plantarum CR12;
Bifidobacterium animalis subsp.lactis U9, having a preservation number of CGMCC No. 11560;
Lactobacillus plantarum CR12, having a preservation number of CGMCC No. 14000;
the ingredient is calculated in parts by weight and comprises:
60 parts of fresh chicken, 15 parts of deboned chicken, 3 parts of fresh chicken liver, 3 parts of sweet potato flour, 3 parts of whole egg powder, 3 parts of chicken oil, 4 parts of fish oil, 3 parts of cassava starch, 0.7 parts of fresh pumpkin, 0.7 parts of broccoli, 0.7 parts of celery, 0.7 parts of carrots, 0.4 parts of beer yeast powder, 0.3 parts of seaweed powder, 0.2 parts of plantain seed powder, 0.3 parts of dried cranberries, and 2 parts of additives; and
the viable count of the Bifidobacterium animalis subsp.lactis U9 in the probiotic cat food is 1×10¹⁰ CFU/kg, the viable count of the Lactobacillus plantarum CR12 in the probiotic cat food is 1×10¹⁰ CFU/kg;
the preparation method for the probiotic cat food, comprising the following steps:
(1) weighting the ingredients according to parts by weight, and mixing the ingredients evenly after chopping and stirring treatment;
(2) adding the evenly mixed ingredients to a granulator, and performing shaping treatment to obtain cat food granules; and
(3) performing three-stage low-temperature baking on the cat food granules, to obtain a baked food;
wherein the conditions for the three-stage low-temperature baking are: baking at 90-100° C. for 30 min, baking at 100-120° C. for 30 min, baking at 80-100° C. for 3 h;
(4) weighing the Bifidobacterium animalis subsp.lactis U9 and Lactobacillus plantarum CR12 powder according to the viable count, and dissolving to obtain probiotic mixed solution; after cooling the baked food, evenly spraying the probiotic mixed solution on the surface of the baked food by using a spraying device, and after the spraying, naturally air-drying the cat food in a sterile and ventilated environment, to obtain the probiotic cat food.

2. The probiotic cat food as claimed in claim 1, wherein the additives comprise: taurine, choline chloride, sodium chloride, potassium chloride, calcium hydrogen phosphate, fructooligosaccharide, mannan oligosaccharide, rosemary extract, tea polyphenol, vitamin A acetate, vitamin D₃, dl-α-tocopherol, thiamine nitrate, riboflavin, niacin, D-calcium pantothenate, pyridoxine hydrochloride, folate, D-biotin, cyanocobalamin, glycine copper chelate, glycine iron chelate, glycine zinc, methionine manganese complex, calcium iodate, and yucca schidigera extract.

3. A preparation method for the probiotic cat food for improving the digestive function of the pet cat as claimed in claim 1, comprising the following steps:
(1) weighting the ingredients according to parts by weight, and mixing the ingredients evenly after chopping and stirring treatment;
(2) adding the evenly mixed ingredients to a granulator, and performing shaping treatment to obtain cat food granules;
(3) performing three-stage low-temperature baking on the cat food granules, to obtain a baked food;
wherein the conditions for the conditions for the three-stage low-temperature baking are: baking at 90-100° C. for 30 min, baking at 100-120° C. for 30 min, baking at 80-100° C. for 3 h; and
(4) weighing the animal bifidobacterium lactobacillus subspecies and Lactobacillus plantarum powder according to the viable count, and dissolving to obtain probiotic mixed solution; after cooling the baked food, evenly spraying the probiotic mixed solution on the surface of the baked food by using a spraying device, and after the spraying, naturally air-drying the cat food in a sterile and ventilated environment, to obtain the probiotic cat food.

4. A preparation method for the probiotic cat food for improving the digestive function of the pet cat as claimed in claim 2, comprising the following steps:
(1) weighting the ingredients according to parts by weight, and mixing the ingredients evenly after chopping and stirring treatment;
(2) adding the evenly mixed ingredients to a granulator, and performing shaping treatment to obtain cat food granules;
(3) performing three-stage low-temperature baking on the cat food granules, to obtain a baked food;
wherein the conditions for the conditions for the three-stage low-temperature baking are: baking at 90-100° C. for 30 min, baking at 100-120° C. for 30 min, baking at 80-100° C. for 3 h; and
(4) weighing the animal bifidobacterium lactobacillus subspecies and Lactobacillus plantarum powder according to the viable count, and dissolving to obtain probiotic mixed solution; after cooling the baked food, evenly spraying the probiotic mixed solution on the surface of the baked food by using a spraying device, and after the spraying, naturally air-drying the cat food in a sterile and ventilated environment, to obtain the probiotic cat food.
